(19) United States
(12) Patent Application Publication
(10) Pub. No.: US 2013/0161061 A1
(43) Pub. Date: Jun. 27, 2013

(54) INSULATED WIRE AND COIL USING THE SAME

(71) Applicant: Hitachi Cable, Ltd., Tokyo (JP)

(72) Inventors: Yuki HONDA, Hitachi (JP); Takami Ushiwata, Hitachi (JP); Shuta Nabeshima, Hitachi (JP); Hideyuki Kikuchi, Hitachi (JP)

(73) Assignee: Hitachi Cable, Ltd., Tokyo (JP)

(21) Appl. No.: 13/689,629

(22) Filed: Nov. 29, 2012

(30) Foreign Application Priority Data
Dec. 22, 2011 (JP) 2011-280845

(51) Int. Cl. H01B 3/30

(52) U.S. Cl. CPC H01B 3/308
USPC 174/110 SR

(57) ABSTRACT

An insulated wire includes a conductor, and an insulation covering on an outer periphery of the conductor, the insulation covering including a low-relative-permittivity insulating film that has a relative permittivity of not more than 3.2 and contains an imide structural component. The low-relative-permittivity insulating film includes a polyimide resin having a repeating unit represented by the following formulas:

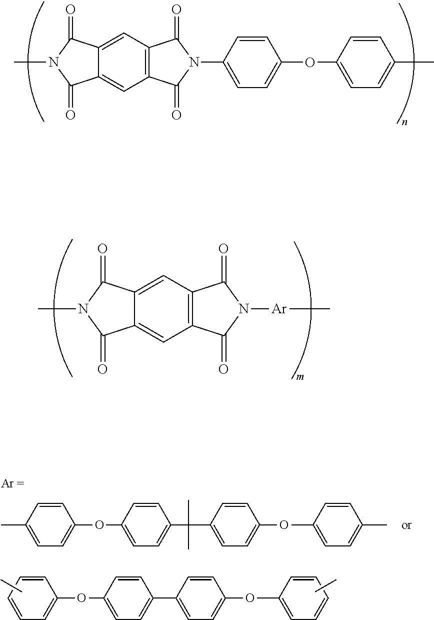

where 0.1≦m/(n+m) and 1≦(m, n).

The present application is based on Japanese patent application No.2011-280845 filed on Dec. 22, 2011, the entire contents of which are incorporated herein by reference.

The invention relates to an insulated wire and, in particular, to an insulated wire suitable for a coil used in electrical devices such as motor or electric transformer, and a coil using the insulated wire.

### DESCRIPTION OF THE RELATED ART

For a coil in electrical devices such as rotating electrical machine or electric transformer, an insulated wire (or enameled wire) is generally widely used in which an insulation covering layer composed of one or two or more insulating films obtained by applying and baking an insulating coating material, which is made of a resin such as polyimide, polyamide-imide and polyester-imide, dissolved in an organic solvent, is provided on an outer periphery of a metal conductor having a cross sectional shape corresponding to the intended use and shape of a coil (e.g., a circular shape or a rectangular shape).

Electrical devices such as rotating electrical machine or electric transformer is becoming driven by inverter control, and inverter surge voltage generated by inverter control may penetrate into such an electrical device using inverter control when the generated inverter surge voltage is high. When an inverter surge voltage penetrates into an electrical device, partial discharge occurs in an insulated wire constituting a coil of the electrical device due to the inverter surge voltage, which may deteriorate/damage an insulating film.

An insulated wire, as a method of preventing deterioration of an insulating film caused by an inverter surge voltage is known that, e.g., an aromatic diisocyanate component having two or less aromatic rings is mixed with an aromatic imide prepolymer containing an aromatic diamine component having three or more aromatic rings and an acid component to form a polyamide-imide resin insulating coating material and an insulating film is formed by applying and baking the polyamide-imide resin insulating coating material on a conductor (see, e.g., JP-A-2009-161683). According to JP-A-2009-161683, an insulating film having a low relative permittivity is obtained by using such a polyamide-imide resin insulating coating material and an insulated wire having a high partial discharge inception voltage (PDIV) is thus obtained.

The related art also may include JP-A-2010-132725.

### SUMMARY OF THE INVENTION

In recent years, electrical devices such as motor need to be downsized and to have high power, so that they are inverter-controlled at higher voltage than before. Thereby, an increase in the electric current flowing through the insulated wire composing a coil than before causes an environment to allow the generation of much heat around the insulated wire.

On the other hand, to densely wind the insulated wire has been proposed so as to improve a space factor of the insulated wire. However, if the space factor is improved, it becomes difficult to dissipate the generated heat, i.e., the heat dissipation performance lowers.

The increased electric current or the decrease in heat dissipation performance as described above causes the insulated wire to be used in a higher temperature atmosphere than before. Therefore, the insulated wire needs have a certain resistance to partial discharge, i.e., it has to prevent the occurrence of partial discharge even in such a high temperature atmosphere. However, the conventional insulated wire has the problem that the partial discharge inception voltage under a high-temperature environment is low. Accordingly, it is an object of the invention to provide an insulated wire that has a high partial discharge inception voltage even under a high-temperature environment, as well as a coil using the insulated wire.

(1) According to one embodiment of the invention, an insulated wire comprises:

a conductor; and

an insulation covering on an outer periphery of the conductor, the insulation covering comprising a low-relative-permittivity insulating film that has a relative permittivity of not more than 3.2 and contains an imide structural component, wherein the low-relative-permittivity insulating film comprises a polyimide resin having a repeating unit represented by the following formulas:

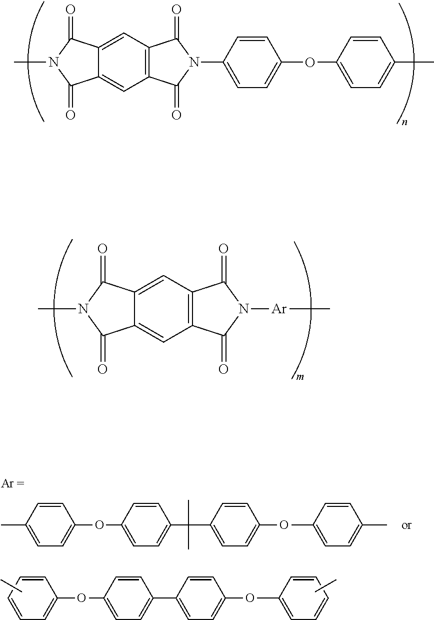

where 0.1≦m/(n+m) and 1≦(m, n).

In the above embodiment (1) of the invention, the following modifications and changes can be made.

(i) The insulation covering further comprises a second insulating film containing an imide structural component between the conductor and the low-relative-permittivity insulating film.

(ii) The insulation covering further comprises a third insulating film having a lubricity on an outer periphery of the low-relative-permittivity insulating film.

(iii) The second insulating film contains an additive for improving adhesion with the conductor.

(2) According to another embodiment of the invention, a coil comprises the insulated wire according to the above embodiment (1).

### EFFECTS OF THE INVENTION

According to one embodiment of the invention, an insulated wire can be provided that has a high partial discharge inception voltage even under a high-temperature environment, as well as a coil using the insulated wire.

### DETAILED DESCRIPTION OF THE PREFERRED EMBODIMENTS

A preferred embodiment of an insulated wire and a coil using the same in the invention will be described below.

### Summary of the Embodiment

An insulated wire of the present embodiment is provided with a conductor and an insulation covering having an insulating film on an outer periphery of the conductor, wherein a low-relative-permittivity insulating film, which is formed of a polyimide resin having a repeating unit represented by a given chemical formula, has a relative permittivity of not more than 3.2 and contains an imide structural component, is used as the insulating film of the insulated wire.

### Embodiment

1. Insulated Wire

The insulated wire of the present embodiment is provided with a conductor, and an insulation covering formed on an outer periphery of the conductor and having a low-relative-permittivity insulating film that has a relative permittivity of not more than 3.2 and contains an imide structural component, wherein the low-relative-permittivity insulating film is formed of a polyimide resin having a repeating unit represented by the following formulas.

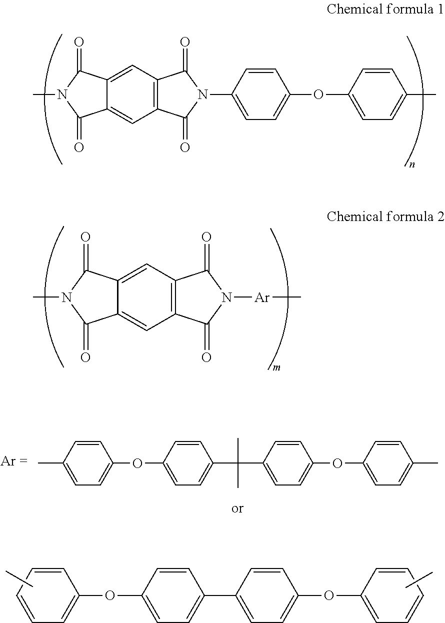

In the formulas, 0.1≦m/(n+m) and 1≦(m, n).

It is especially suitable for obtaining a high partial discharge inception voltage even in a high-temperature environment when the insulation covering further includes a second insulating film containing an imide structural component on the conductor side of the low-relative-permittivity insulating film. Each constituent element will be described below.

Low-Relative-Permittivity Film

The insulation covering used for the insulated wire in the present embodiment has a low-relative-permittivity insulating film containing an imide structural component. In detail, the low-relative-permittivity insulating film has a relative permittivity of not more than 3.2 and is formed of a polyimide resin having a repeating unit represented by the above formulas. Use of the polyimide resin having a repeating unit represented by the above formulas as a material of the low-relative-permittivity insulating film allows a polyimide resin to have a reduced concentration of imide group, which is a polar group, without decreasing heat resistance. More preferably, the imide concentration expressed by dividing a molecular weight of the imide structure by a molecular weight of a unit chemical structure is not less than 15% and not more than 36%. In order to obtain the imide concentration in such a range, a polyimide resin in which a structural unit represented by the chemical formula 1 and a structural unit represented by the chemical formula 2 are contained at a molar ratio (mol %) of “90/10 to 10/90” should be used. A manufacturing method thereof is not specifically limited as long as the polyimide resin has insulation properties and an imide concentration of not less than 15% and not more than 36%, however, in case of synthesizing by an imidization reaction of an acid dianhydride with a diamine or by a reaction of an acid dianhydride with a diisocyanate, it is possible to synthesize a polyimide with a further reduced imide concentration if molecular weights of the acid dianhydride and the diamine are large.

A resin constituting the low-relative-permittivity insulating film can be a polyamide obtained by reacting, e.g., a tetracarboxylic dianhydride made of pyromellitic dianhydride (PMDA), etc., with a diamine such as 4,4° -diaminodiphenyl ether (ODA), 2,2-bis[4-(4-aminophenoxy)phenyl]propane (BAPP), 4,4′-bis(4-aminophenoxy)biphenyl (BAPB) or 3,3′-bis(4-aminophenoxy)biphenyl (M-BAPB).

The polyimide resin having a repeating unit represented by the above formulas is prepared by appropriately combining the tetracarboxylic dianhydrides and the diamines.

An insulating coating material formed by dissolving the above-mentioned polyimide resin in an organic solvent such as N-methyl-2-pyrrolidone is applied and baked on the conductor, thereby forming the low-relative-permittivity insulating film.

Second Insulating Film

The insulation covering used for the insulated wire of the present embodiment can be configured such that, in addition to the low-relative-permittivity insulating film containing an imide structural component, the second insulating film containing an imide structural component is further included on the conductor side of the low-relative-permittivity insulating film. In other words, the insulation covering can be formed of the second insulating film and the low-relative-permittivity insulating film in this order from the conductor side.

The second insulating film is not specifically limited as long as it is formed of a resin containing an imide structural component in a molecule thereof Resins, e.g., polyimide, polyamide-imide and polyester-imide, etc., can be used as the resin containing an imide structural component in a molecule thereof. In detail, for example, a polyimide formed by mixing a tetracarboxylic dianhydride made of pyromellitic dianhydride (PMDA), etc., with a diamine compound made of 4,4′-diaminodiphenyl ether (ODA), etc., at equimolar amounts, a polyamide-imide formed by mixing a tricarboxylic acid anhydride such as trimellitic anhydride (TMA) with an isocyanate such as 4,4′-diphenylmethane diisocyanate (MDI) at equimolar amounts, and a polyester-imide modified with tris(2-hydroxyethyl) isocyanurate can be used.

An insulating coating material formed by dissolving the above-mentioned resin in an organic solvent is applied and baked on the conductor, thereby forming the second insulating film.

Alternatively, a commercially available insulating coating material may be used for forming the second insulating film and it is possible to use, e.g., a polyimide resin insulating coating material such as “Torayneece#3000” manufactured by Toray Industries, Inc. or “Pyre-ML” manufactured by DuPont, a polyamide-imide resin insulating coating material such as “HI406” manufactured by Hitachi Chemical Co., Ltd., and a polyester-imide resin insulating coating material such as “Isomid40SM45” manufactured by Hitachi Chemical Co., Ltd.

In addition, it is preferable that the second insulating film contain an additive, e.g., melamine-based compounds such as alkylated hexamethylol melamine resin or elemental sulfur-containing compounds typified by mercapto series. It is possible to use an additive other than such compounds as long as exhibiting high adhesion.

Third Insulating Film

The insulation covering used for the insulated wire of the present embodiment can be can be configured such that, in addition to the low-relative-permittivity insulating film containing an imide structural component, a third insulating film having lubricity is further included on an outer periphery of the low-relative-permittivity insulating film. In other words, the insulation covering can be formed of the low-relative-permittivity insulating film and the third insulating film in this order from the conductor side, or the second insulating film, the low-relative-permittivity insulating film and the third insulating film in this order from the conductor side.

The third insulating film has lubricity to prevent the insulation covering from being broken or being peeled off when a coil is formed using the insulated wire of the present embodiment. In detail, a lubricant coating material which is an enamel coating, such as polyimide, polyester-imide or polyamide-imide, containing a lubricant component can be used. Here, the lubricant component refers to one selected from the group consisting of polyolefin wax, fatty acid amide and fatty acid ester, or a mixture of two or more thereof. Polyolefin wax or fatty acid amide alone, or a mixture thereof is particularly preferable but it is not limited thereto. Alternatively, it is possible to use a lubricant enamel coating material in which an aliphatic component having lubricity is introduced into a chemical structure of the enamel coating. It is possible to form these lubricant insulating films by applying and baking an insulating coating material.

Conductor

A material of the conductor used for the insulated wire of the present embodiment is, e.g., copper, and oxygen-free copper and low oxygen copper are mainly used. However, it is not limited to a conductor formed of copper and it is possible to use a conductor which is, e.g., copper with a metal such as nickel plated on an outer periphery thereof. In addition, it is possible to use a conductor of which cross sectional shape is circular or rectangular, etc. The rectangular shape here means that a substantially rectangular shape with four rounded corners is included.

Coil

A coil in the invention is formed using the above-mentioned insulated wire. The coil in the present embodiment is formed by, e.g., elongating and then bending the insulated wire.

### Examples

The insulated wire of the invention will be described in more detail below by referring to Examples. It should be noted that typical examples of the insulate wire of the invention are shown in Examples and the invention is not limited to Examples.

Polyimide resin coating materials and enameled wires in Examples and Comparative Example were prepared as follows.

Synthesis of Polyimide Resin Coating Material (PM)

A tetracarboxylic dianhydride made of pyromellitic dianhydride (PMDA) and a diamine, which is made of 4,4′-diaminodiphenyl ether (ODA) and 2,2-bis[4-(4-aminophenoxy)phenyl]propane (BAPP), were mixed at equimolar amounts and were stirred in a solvent made of N-methyl-2-pyrrolidone (NMP), thereby obtaining a polyimide resin coating material (PI-1).

Synthesis of Polyimide Resin Coating Material (PI-2)

A tetracarboxylic dianhydride made of pyromellitic dianhydride (PMDA) and a diamine made of 4,4′-diaminodiphenyl ether (ODA) were mixed at equimolar amounts and were stirred in a solvent made of N-methyl-2-pyrrolidone (NMP), thereby obtaining a resin coating material. Then, a low-density polyethylene was added in an amount of 5 parts by weight per 100 parts by weight of the resin content in the resin coating material, thereby obtaining a polyimide resin coating material (PI-2).

Synthesis of Polyimide Resin Coating Material (PI-3)

A tetracarboxylic dianhydride made of pyromellitic dianhydride (PMDA) and a diamine made of 4,4′-diaminodiphenyl ether (ODA) were mixed at equimolar amounts and were stirred in a solvent made of N-methyl-2-pyrrolidone (NMP), thereby obtaining a resin coating material. Then, an alkylated methylol melamine was added in an amount of 1 part by weight per 100 parts by weight of the resin content in the resin coating material, thereby obtaining a polyimide resin coating material (PI-3).

Synthesis of Polyimide Resin Coating Material (PI-4)

A tetracarboxylic dianhydride made of pyromellitic dianhydride (PMDA) and a diamine made of 4,4′-diaminodiphenyl ether (ODA) were mixed at equimolar amounts and were stirred in a solvent made of N-methyl-2-pyrrolidone (NMP), thereby obtaining a polyimide resin coating material (PI-4).

### Example 1

A low-relative-permittivity insulating film (a first insulating film) was formed by applying and baking the polyimide resin coating material (PI-1) on a copper conductor, thereby obtaining an insulated wire of Example 1.

### Example 2

A lower insulating film as a second insulating film was formed by applying and baking the polyimide resin coating material (PI-3) on a copper conductor, and in addition, an upper insulating film as a low-relative-permittivity insulating film (a first insulating film) was formed by applying and baking the polyimide resin coating material (PI-1) on a surface of the second insulating film, thereby obtaining an insulated wire of Example 2.

### Example 3

A lower insulating film as a low-relative-permittivity insulating film (a first insulating film) was formed by applying and baking the polyimide resin coating material (PI-1) on a copper conductor, and in addition, an upper insulating film as a third insulating film was formed by applying and baking the polyimide resin coating material (PI-2) on a surface of the first insulating film, thereby obtaining an insulated wire of Example 3.

### Example 4

A lower insulating film as a second insulating film was formed by applying and baking the polyimide resin coating material (PI-3) on a copper conductor, an intermediate insulating film as a low-relative-permittivity insulating film (a first insulating film) was then formed by applying and baking the polyimide resin coating material (PI-1) on a surface of the second insulating film, and in addition, an upper insulating film as a third insulating film was formed by applying and baking the polyimide resin coating material (PI-2) on a surface of the first insulating film, thereby obtaining an insulated wire of Example 4.

### Comparative Example 1

A first insulating film was formed by applying and baking the polyimide resin coating material (PI-4) on a copper conductor, thereby obtaining an insulated wire of

### Comparative Example 1

Measurement of Partial Discharge Inception Voltage

The partial discharge inception voltage was measured by the following procedure. A 500 mm-long sample was cut out from the obtained insulated wire, a sample of twisted-pair insulated wire was made, and an end processed portion was formed by removing the insulating film to a position of 10 mm from an edge. For the measurement, a partial discharge inception voltage test system (DAC-PD-3, manufactured by Soken Electric Co., Ltd.) was used. An electrode was connected to the end processed portion, and then, AC voltage having a sine wave of 50 Hz was applied to the sample in an atmosphere at a temperature of 23° C. and humidity of 50% or in an atmosphere at 220° C. while increasing the voltage at a rate of 10 to 30 V/s up to voltage at which 100 pC of discharge occurs 50 times per second. This was repeated three times and the lowest value was defined as a partial discharge inception voltage (PDIV). Note that, in Table 1, not less than 970 Vp of PDIV at 220° C. is regarded as “◯” (passed the test) and less than 970 Vp of PDIV at 220° C. is regarded as “X (failed)”.

Flexibility For the flexibility test, the sample taken from each of the obtained insulated wires was elongated 30% by a method in accordance with JIS C 3003, and was subsequently wound around a round bar (a winding rod) having a smooth surface and a diameter 1 to 10 times a conductor diameter by a method in accordance with JIS C 3003 so as to form five coils where one coil is formed by winding five times. A minimum winding rod diameter (d) at which occurrence of cracks on the insulating film is not observed at the time of winding was used as an index of flexibility, and the minimum winding rod diameter of ld was regarded as “⊚” (excellent), 2d was regarded as “◯” (passed the test) and 3d or more was regarded as failed.

Relative permittivity An insulated wire in which a low-relative-permittivity insulating film formed of the polyimide resin coating material (PI-1) is formed on the conductor, or an insulated wire in which a first insulating film formed of the polyimide resin coating material (PI-4) is formed on the conductor was made, a 250 mm-long sample was cut out from each of the obtained insulated wires and was elongated 2%, and the insulating film at one edge was removed. Subsequently, an electrode was formed by platinum sputtered on a surface of each sample after heat treatment at 120° C. for 30 minutes. Capacitance of each sample having the electrode formed thereon was measured at a frequency of 1 kHz using an impedance analyzer and the relative permittivity (εₛ) was calculated based on the following formula 1.

ε_{S}=(C/2πε₀)×In(D/d)×(1/L) (formula 1)

Here, C represents capacitance of the measured sample, ε₀ represents permittivity of vacuum, D represents an outer diameter of the sample, d represents an outer diameter of the conductor of the sample and L represents a length of the electrode.

Table 1 shows results of measurement and evaluation of each test for Examples and Comparative Example. Note that, in the section of Items in Table 1, the configuration of the insulation covering is separately shown as three constituent elements, the upper insulating film, the intermediate insulating film and the lower insulating film.

TABLE 1

| | | | | | | Comparative |
|---|---|---|---|---|---|---|
| Items | | Example 1 | Example 2 | Example 3 | Example 4 | Example 1 |
| Insulation | Upper insulating | Low-relative- | Low-relative- | (PI-2) | (PI-2) | (PI-4) |
| covering | film | permittivity | permittivity | | | |
| | | insulating film | insulating film | | | |
| | | (PI-1) | (PI-1) | | | |
| | Intermediate | | | | Low-relative- | |
| | insulating film | | | | permittivity | |
| | | | | | insulating film | |
| | | | | | (PI-1) | |
| | Lower insulating | | (PI-3) | Low-relative- | (PI-3) | |
| | film | | | permittivity | | |
| | | | | insulating film | | |
| | | | | (PI-1) | | |

| | | | | | |
|---|---|---|---|---|---|
| Partial discharge inception | ◯ | ◯ | ◯ | ◯ | X |
| voltage (220° C.) | | | | | |
| Flexibility | ◯ | ⊚ | ◯ | ⊚ | ◯ |
| (after 30% elongation) | (2 d) | (1 d) | (2 d) | (1 d) | (2 d) |
| Relative permittivity | 3.0 | 3.0 | 3.0 | 3.0 | 3.4 |
| (first insulating film) | | | | | |

As shown in Table 1, it is understood that Examples 1 to 4 exhibit a high partial discharge inception voltage at high temperature (220° C.). On the other hand, a partial discharge inception voltage at high temperature is low in Comparative Example 1. That is, since the low-relative-permittivity insulating film having a relative permittivity of not more than 3.2 and formed of a polyimide resin having a repeating unit represented by the above formulas is used as the insulating film constituting the insulation covering, it is possible to obtain a high partial discharge inception voltage at high temperature.

In addition, from comparison between Examples 1 and 2, it is understood that flexibility of Example 2 is more excellent than Example 1. The reason thereof is presumed that, in the case of Example 2, adhesion between the conductor and the second insulating film is improved since the resin constituting the second insulating film contains an additive (alkylated methylol melamine) which improves adhesion, and flexibility is also improved.

Furthermore, surfaces of the insulated wires in Examples 3 and 4 are smoother and excellent in lubricity as compared to Examples 1 and 2. The reason thereof is presumed that lubricity of the surface of the insulation covering was improved since the resin constituting the upper insulating film (the third insulating film) contains a lubricant component which improves lubricity.

As described above, the invention is an insulated wire provided with a conductor and an insulation covering in which a low-relative-permittivity insulating film having a relative permittivity of not more than 3.2 and containing an imide structural component is included on an outer periphery of the conductor, and the low-relative-permittivity insulating film formed of a polyimide resin having a repeating unit represented by the above formulas allows the insulated wire to have a high partial discharge inception voltage even under a high-temperature environment.

Although a polyimide resin coating material is used for the second and third insulating films of the insulated wires in Examples, it is not limited thereto and it is possible to obtain the same effects even in the case of using, e.g., a polyamide-imide resin coating material or a polyester-imide resin coating material in place of the polyimide resin coating material.

Although the invention has been described with respect to the specific embodiments and Examples for complete and clear disclosure, the appended claims are not to be thus limited. In particular, it should be noted that all of the combinations of features as described in the embodiment and Examples are not always needed to solve the problem of the invention.

What is claimed is:

1. An insulated wire, comprising:
a conductor; and
an insulation covering on an outer periphery of the conductor, the insulation covering comprising a low-relative-permittivity insulating film that has a relative permittivity of not more than 3.2 and contains an imide structural component,
wherein the low-relative-permittivity insulating film comprises a polyimide resin having a repeating unit represented by the following formulas: 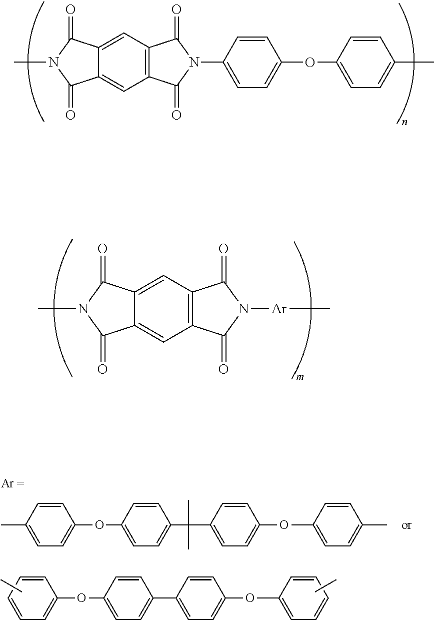
where 0.1≦m/(n+m) and 1≦(m, n).

2. The insulated wire according to claim 1, wherein the insulation covering further comprises a second insulating film containing an imide structural component between the conductor and the low-relative-permittivity insulating film.

3. The insulated wire according to claim 1, wherein the insulation covering further comprises a third insulating film having a lubricity on an outer periphery of the low-relative-permittivity insulating film.

4. The insulated wire according to claim 2, wherein the second insulating film contains an additive for improving adhesion with the conductor.

5. A coil comprising the insulated wire according to claim 1.
